(19) United States
(12) Patent Application Publication
(10) Pub. No.: US 2007/0255670 A1
(43) Pub. Date: Nov. 1, 2007

(54) Method and System for Automatically Producing Computer-Aided Control and Analysis Apparatuses

(75) Inventors: Francois Ruf, Zurich (CH); Leo Keller, Rorbas-Freienstein (CH); Ales Prochazka, Zurich (CH)

Correspondence Address: OLIFF & BERRIDGE, PLC, P.O. BOX 19928, ALEXANDRIA, VA, 22320, US

(73) Assignee: NETBREEZE GMBH, Dubendorf (CH)

(21) Appl. No.: 11/596,809

(22) PCT Filed: May 18, 2004
(86) PCT No.: PCT/EP04/50839

§ 371 Date: Nov. 17, 2006

(51) Int. Cl. G06N 5/02

(52) U.S. Cl. 706/50

(57) ABSTRACT

The invention relates to a system and method for the automated generation of complex control and/or analysis devices, whereby a task-specific organizational profile based on at least task condition data and/or object condition data and/or transfer condition data is generated. A first processing unit having at least one data aggregation module is generated. A second processing unit having at least one data analysis module is generated. A third processing unit having at least one data representation module is generated. Data channels generated by means of at least one work flow are connected to the at least one data aggregation module and/or data analysis module and/or data representation module. A data flow is defined by means of data channels between the modules in accordance with the task-specific organizational profile.

The invention relates to a system and a method for automatically producing complex control and/or analysis apparatuses, which control and analysis apparatuses are used to aggregate, analyze and present data from decentralized databases. The invention relates particularly to a system and a method for realtime analysis of multimedia data stored in decentralized fashion and/or for dynamic realtime adaptation of control systems or apparatuses.

Today, it is no longer possible to imagine industry and technology without automated control and analysis systems. These range from simple control modules, which use information stored in an EEPROM (Electrically Erasable Programmable Read-Only Memory), for example, to control miniaturized devices, through complex analysis and control systems, such as expert systems or adaptive systems based on neural networks. At the same time, the data required for analysis or control have become almost impossible for the individual user to take in as a result of the vast quantity of relevant and available information, such as on the Internet or in the worldwide Backbone network, and their complex structuring in a wide variety of data sources. The systems available in the prior art can be vastly complex and can be obtained by the individual user often only as a complete package designed for a specific problem. In addition, once they have been produced, the user is normally no longer able to adapt these systems to new requirements or is able only to adapt them with difficulty. If the systems have an adaptive response, however, such as the aforementioned systems based on neural networks, then these systems are usually a black box for the user without there being any deeper understanding of the data to be analyzed or of the control sequences. In addition, these adaptive systems all have the drawback that they exhibit an adaptive response only within the limits provided for them.

An example which may be used for a representative of such analysis systems is, inter alia, search engines, such as the known Internet search engines with, by way of example, the known AltaVista engine as a word-based search engine or, by way of example, the Yahoo engine as a topic-based search engine. Search engines allow the user to use a large number of decentralized data sources, since without such aids there is a drastic reduction in the prospect of actually finding as much of the relevant data as possible. Despite all the progress in this field, the search engine technology available in the prior art frequently does not provide the user with any really satisfactory responses, however. One example which may be taken is that a user wishes to find information about, by way of example, the Fiat Uno car model type, for example in connection with a liability claim for product liability regarding a faulty design with technical consequences. General search engines will typically provide a large number of irrelevant links for this topic in regard to the keyword “Uno” or “Fiat Uno”, since the search engines cannot recognize the context (in this case the legal context) in which the search term is found. In this case, only little assistance is frequently found in a possible combination of search terms too. One of the reasons for this is that Internet search engines usually pursue the “any document is relevant” strategy, which is why they try to detect and index any accessible document. Their mode of operation is always based on this unedited selection of documents. Another drawback of search engines in the prior art is that the hierarchy of documents found can easily be manipulated by the provider (URL, title, frequency in the content, metatags, etc.), which provides a distorted picture of the documents found. Classification of the documents by the provider is perhaps possible for a few individual areas. However, the vast quantity of data and the fact that the information on the network can quickly change (newsgroups, portals, etc.) mean that a provider is unable to classify all relevant documents relating to all arising topics directly or to interpret their content. The situation becomes even more difficult if, instead of specific topics, the aim is to detect general mood trends, opinion trends or mood fluctuations in the users of the network. By way of example, it may be important to the survival of a company or industry (for example tobacco, chemicals, etc.) to have early detection of the possibilities of class action (USA) or a liability claim against it on the basis of published documents on the Internet and to take appropriate precautions early. Precisely for such examples, traditional search engines cannot be used or can be used only to a certain extent. In particular, they do not allow effective realtime monitoring, which may be necessary in such a case. It is also important to understand from the example that the user has only very limited influence, if any at all, on the basic operation of these analysis means.

It is an object of this invention to propose a novel system and a method for automatically producing complex control and/or analysis apparatuses which do not have the aforementioned drawbacks of the prior art. In particular, the aim is to propose an automated, simple and rational system and method for performing complex, content-oriented checks and analyses. For checking, possible filter parameters are meant to be, in particular, parameters which are not related to the topic and/or are not highly tangible, such as moods or mood fluctuations in the network users. The inventive method and system are likewise intended to allow the user to make realtime adaptations to the workflow of the control system and/or analysis system easily, e.g. on the basis of the locally stored data.

The present invention achieves this aim particularly by means of the elements of the independent claims. Further advantageous embodiments can also be found in the dependent claims and in the description.

In particular, these aims are achieved by the invention in that complex control and/or analysis apparatuses are automatically produced by aggregating and/or analyzing and/or presenting data from decentralized databases, in that a task-specific organization profile is produced on the basis of at least task condition data and/or object condition data and/or transfer condition data, in that a list having at least one data aggregation module is generated, with each data aggregation module being allocated one or more predefined data transmission protocols and/or access protocols for the databases which are to be analyzed, in that a list having at least one data analysis module is generated, with each data analysis module being allocated one or more predefined metadata types and/or analysis units, which metadata types and/or analysis units are taken as a basis for analyzing aggregated data from the decentralized databases, in that a list having at least one data representation module is generated, with each data representation module being allocated one or more predefined data presentation modules, and in that data channels generated by a workflow module are used to connect the at least one data aggregation module and/or data analysis module and/or data representation module in an association, with a flow of data being defined by means of data channels between the modules in line with task-specific profile. The metadata can be generated at least to some extent dynamically, for example, and at least to some extent on the basis of the data from the a task-specific profile, for example. The databases can be accessed via network nodes connected to a network, for example. This has the advantage, inter alia, that the production of complex control and/or analysis apparatuses can be fully automated without the need for the user to have any great prior knowledge of programming techniques. In addition, the sequences within the control and/or analysis apparatuses, such as the flow of data, remain transparent for the user at all times and can be altered or adapted as appropriate. The data presentation modules may comprise, in particular, an HTML (HyperText Markup Language) and/or HDML (Handheld Device Markup Language) and/or WML (Wireless Markup Language) and/or VRML (Virtual Reality Modeling Language) and/or ASP (Active Server Pages) module, for example.

In one variant embodiment, the task-specific organization profile is produced automatically by means of an expert module. By way of example, the expert module may comprise adaptive identification and analysis units, for example on the basis of neural network modules. This variant embodiment has the advantage, inter alia, that the production and/or adaptation of the complex control and/or analysis apparatuses can be automated further.

In another variant embodiment, the association by the data channels is made at least to some extent dynamically. This variant embodiment has the advantage, inter alia, that the flow of data can be altered in real time. This has not been possible at all to date in the prior art.

In one variant embodiment, output data from the control and/or analysis apparatuses and/or references to output data are stored in a data store in a content module. This variant embodiment has the advantage, inter alia, that the result of an analysis or a request can be checked at any time by a user, for example using a mobile or fixed network terminal.

In yet another variant embodiment, at least one of the decentralized databases is used to store output data from the control and/or analysis apparatuses, with the data aggregation modules accessing this at least one database. This variant embodiment has the advantage, inter alia, that the control and/or analysis apparatuses can also be used to generate “recursive” and/or feedback flows of data, which can be altered dynamically, for example. By way of example, it is conceivable to take definable equilibrium conditions as a basis for dynamically altering the organization profile using the expert module, for example. This is a great advantage, particularly in the case of complex dynamic processes, which has not been able to be achieved to date with the prior art.

In one variant embodiment, data aggregation modules, data analysis modules and data representation modules are connected at least to some extent recursively by means of the data channels via the workflow module. This variant embodiment has the same advantages, inter alia, as the preceding one. In particular, it also allows complex dynamic processes to be detected (e.g. even in real time).

At this juncture, it should be stated that the present invention relates not only to the inventive method but also to a system for carrying out this method. In addition, it is not limited to said system and method, but rather likewise relates to a computer program product for implementing the inventive method.

Variant embodiments of the present invention are described below with the aid of examples. The examples of the embodiments are illustrated by the following appended figures:

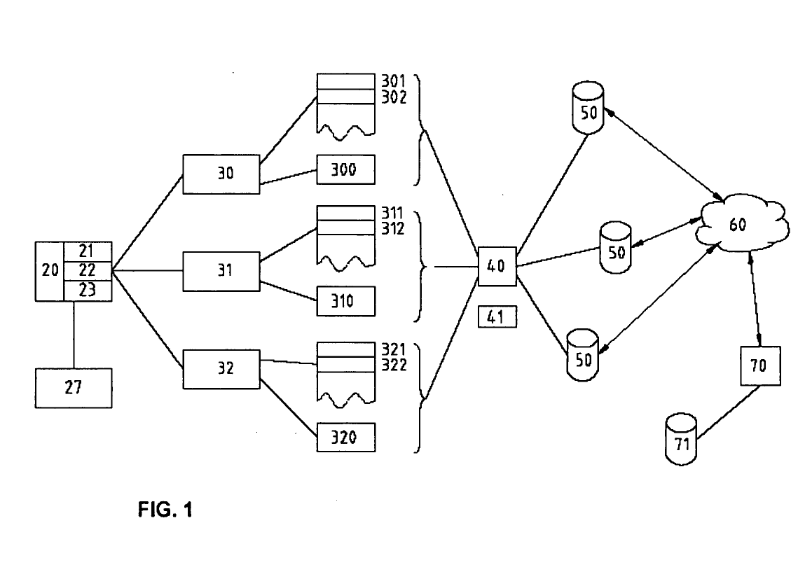

FIG. 1 schematically shows the way in which an inventive system for automatically producing complex control and/or analysis apparatuses works. FIG. 2 depicts schematically an organizational profile of the impact module for a search engine.

FIG. 1 schematically illustrates an architecture which can be used to implement the invention. In this exemplary embodiment, complex control and/or analysis apparatuses are automatically produced by means of the control and/or analysis apparatuses by aggregating, analyzing and presenting data from decentralized databases 50. The databases 50 can be accessed via network nodes connected to a network 60, for example. In this case, the term database 50 is intended to be understood in its widest possible sense. By way of example, such a database 50 may comprise not only one or more memory modules for data storage but also data capture apparatuses, such as sensors and/or meters, which can be used to monitor apparatuses and systems directly. The data may be provided in conditioned form in the database 50. In this case, data are understood to mean all possible kinds of data, such as, in particular, multimedia data, such as, inter alia, digital data such as text, graphics, images, maps, animations, moving images, video, QuickTime, audio recordings, programs (software), program-accompanying data and hyperlinks or references to multimedia data. By way of example, these also include MPx (MP3) or MPEGx (MPEG4 or 7) standards, as defined by the Moving Picture Experts Group. The network 50 can comprise communication networks, in particular, such as a mobile radio network (PLMN: Public Land Mobile Network), such as a GSM (Global System for Mobile communication) or a UMTS network (Universal Mobile Telephone System) or a satellite-based mobile radio network, and/or one or more landline networks, for example the Public Switched Telephone Network (PSTN), the worldwide Internet or a suitable LAN (Local Area Network) or WAN (Wide Area Network). In particular, it also comprises ISDN and XDSL connections. A task-specific and/or user-specific organization profile 20 is produced on the basis of at least task condition data 21 and/or object condition data 22 and/or transfer condition data 23. By way of example, the task condition data 21 may comprise information relating to inventive modules which relate to the production and/or manipulation of data units. By way of example, the object condition data 22 may comprise information relating to the data units which the modules process and/or forward to other modules. By way of example, the transfer condition data 23 may comprise information relating to data channels which connect the individual inventive modules unidirectionally and/or bidirectionally and/or even recursively and at least to some extent determine the flow of data and the processing direction within the complex control and/or analysis apparatuses. By way of example, the transfer condition data 23 may be divided into data relating to a start module, an end module and data relating to the manner in which data units are to be transferred as between the modules. By way of example, the transfer conditions may relate to data and/or metadata. One example of such transfer condition data 23 may be:

| | |
|---|---|
| start-component-id = | data-access-component |
| end-component-id = | data-analysis-component |
| (Conditions relating to metadata) | |
| Project-id = | test-project & |
| language = | english |
| (Time conditions) | |
| date > | Oct. 3, 2003 |

The inventive modules may comprise, by way of example, name/ID of the module, possible input, possible output and module-specific configurations. They can comprise an input interface and/or an output interface or a combination of these. The task-specific organization profile 20 can be produced automatically and/or to some extent automatically by means of an expert module (27), for example. Such an expert module may be formed on the basis of neural networks and/or other artificial intelligence systems, for example. The expert module may, by way of example, also comprise at least to some extent adaptive elements, which allows realtime adaptation of the control and/or analysis apparatuses to changed conditions, for example.

A first processing unit 30 is generated using at least one data aggregation module 301, 302, . . . , with each data aggregation module 301, 302, . . . being allocated one or more predefined data transmission protocols 300 and/or access protocols 300 for the databases 50 which are to be analyzed. The first processing unit 30 can be implemented in hardware and/or software, for example. The data aggregation module 301, 302, . . . may comprise “agents” implemented in software and/or hardware, such as access agents and/or upload/download agents and/or monitoring agents. As an example, the data aggregation modules 301, 302 may comprise the following agents: Web Resource Access Agent, Web Resource Observer Agent, Web Resource Crawler Agent, Web Search Engine Agent, Newsgroup Access Agent, Newsgroup Upload Agent, Newsgroup Observer Agent, Newsgroup Channel Observer Agent, Chat Access Agent, Chatter Agent, Chat Room Observer Agent, FTP Access Agent, FTP Upload Agent, FTP Observer Agent, Mail Access Agent, Mail Upload Agent, Mail Observer Agent, Database Access Agent, Database Upload Agent, Database Observer Agent, File Access Agent, File Upload Agent, File Resource Observer Agent, File Directory Observer Agent, XML Service Agent and/or Java Agent. The agents can be used by the workflow module to implement access to the network objects corresponding to their name.

A second processing unit 31 is generated using at least one data analysis module 311, 312, . . . , with each data analysis module 311, 312, . . . being allocated one or more predefined metadata types 310 and/or analysis units 310, which are taken as a basis for analyzing aggregated data from the decentralized databases 50. The metadata 310 are extracted using a content-based indexing technique, for example, and may comprise keywords, synonyms, references to multimedia data (e.g. including hyperlinks), image and/or audio sequences, etc. Such systems are known in a wide variety of variations in the prior art. Examples are U.S. patent specification U.S. Pat. No. 5,414, 644, which describes a three-file indexing technique, or U.S. patent specification U.S. Pat. No. 5,210,868, which additionally also stores synonyms as search keywords when indexing the multimedia data and extracting the metadata 310. In the present exemplary embodiment, the metadata 310 may also be produced at least to some extent dynamically (in real time), e.g. including on the basis of user data from a user profile, however. This has the advantage that the metadata 310 always have the level of currency and accuracy which is appropriate for the user, for example. From the user behavior, e.g. on a communication apparatus for accessing the complex control and/or analysis apparatuses, to a metadata extraction module there may thus be a kind of feedback option which can directly influence the extraction. The metadata 310 can be dynamically generated in particular at least to some extent on the basis of the data from the task-specific organization profile 20. It is also possible to use “agents” implemented in software and/or hardware, as in the case of data aggregation. As an example, the data analysis modules 311, 312, . . . may comprise the following agents: Information Extraction Analyzer (this analyzer can be used to extract portions of text from a text file, for example. The relevant portions of text can be specified on the basis of the data aggregation modules 301, 302, . . . for example), Text Classification Analyzer (this analyzer can be used to check a text content for a particular topic, for example), Topic Identifier Analyzer (this analyzer can be used to extract an unspecified portion of a text file, for example), Topic Relevance Analyzer (this analyzer can be used to identify topics according to their relevance in a text file, for example), Topic Relevance Analyzer (this analyzer can be used to determine the relevance of different topics within a text, for example), Keyword Extractor Analyzer (this analyzer can be used to extract the most important keywords from a text, for example), Stakeholder Type Analyzer (this analyzer can be used to classify network objects according to prescribed data keys and/or records, for example), Text Summary Analyzer (this analyzer can be used to generate a summary of a text file automatically, for example), URI Analyzer (this analyzer can be used to extract the URI (Uniform Resource Identifier) of a network object, for example), Special IE Analyzer (this analyzer can be used to extract specific information, e.g. regarding time and/or language and/or author and/or location and/or person and/or company etc., for example), Resource Compare Analyzer (this analyzer can be used to compare two network objects and to list and/or tabulate any changes, for example. The changes may relate both to the objects and to the metadata), basic AI (Artificial Intelligence) analyzer (this analyzer can be used to implement different tasks, in particular adaptive tasks and/or tasks with learning capability, such as tokenizers, gazetteers, file positions and/or language markers (taggers), paragraph splitters, sentence splitters, semantic taggers, conference matchers, grammatical parsers, machine learning algorithms, neural networks etc., for example) and/or Pre-Knowledge Module (this module is not used as an analyzer directly, but rather this module can be used to check grammar, dictionaries (e.g. technical dictionaries, etc.), taxonomy etc. upon analyzer input and/or output, for example).

A third processing unit 32 is generated using at least one data representation module 321, 322, . . . , with each data representation module 321, 322, . . . being allocated one or more predefined data presentation modules 320. It is also possible to use “agents” and/or modules implemented in software and/or hardware, as in the case of data aggregation and data analysis. As an example, the data representation modules 321, 322, . . . may comprise the following modules: Data Retrieval Module (this module can be used as a search engine module, for example. It may also have access to all commands and files generated by the workflow module, for example), Chart Engine (this module can be used to generate charts and/or diagrams from one or more network objects, for example, i.e. objects which can be accessed via the network and the decentralized databases), PDF Report Engine (this module can be used to write a PDF report relating to one or more network objects, for example) and/or Web Application Module (this module can be used to write web pages, particularly in HTML (HyperText Markup Language) and/or HDML (Handheld Device Markup Language) and/or WML (Wireless Markup Language) and/or VRML (Virtual Reality Modeling Language) etc., for example).

Data channels 41 generated by a workflow module 40 are used to connect the at least one data aggregation module 301, 302, . . . and/or data analysis module 311, 312, . . . and/or data representation module 321, 322, . . . in an association, with a flow of data being defined by means of data channels 41 between the modules 301, 302, 311, 312, 321, 322, . . . in line with the task-specific organization profile 20. The workflow module 40 may be divided, by way of example, into a task configuration unit and/or task generator unit and/or transfer condition configuration unit and/or transfer condition generator unit. By way of example, the task configuration unit can alter an existing configuration for the workflow of the control and/or analysis apparatuses, whereas the task generator unit can generate workflow afresh and/or can add it, i.e. connects modules using new data channels 41. The transfer condition configuration unit can alter or modify existing configurations for the transfer conditions between the modules, for example, whereas the transfer condition generator unit can generate transfer conditions for the data channels 41 afresh and/or can add them. It should be pointed out that as a variant embodiment the workflow module can modify and/or alter the control and/or analysis apparatuses dynamically or to some extent dynamically during operation. Thus, by way of example, the data channels 41 can also be associated at least to some extent dynamically, with a user also having interactive modification options, for example. Similarly, the data aggregation modules 301, 302, . . . , data analysis modules 311, 312, . . . and data representation modules 321, 322, . . . can be connected at least to some extent recursively by means of the data channels 41 via the workflow module 40, for example. As in the case of the data aggregation, data analysis or data representation, it is also possible to use “agents” and/or modules implemented in software and/or hardware. As an example, the workflow module may comprise the following modules: Transition Condition Configurator (this module can be used to modify existing transfer condition data, for example), Transition Condition Generator (this module can be used to generate new transfer condition data 23, for example), Task Configurator (this module can be used to modify existing task condition data 21, for example) and/or Task Generator (this module can be used to generate new task condition data 21, for example).

It is important to point out that, as one variant embodiment, output data from the control and/or analysis apparatuses and/or references to data output can be made available to a user in a form stored in a data store in a content module. The output data and/or portions of the output data from the control and/or analysis apparatuses can be stored in at least one of the decentralized databases 509, with the data aggregation modules 301, 302, . . . accessing this at least one database. This may be appropriate in the case of adaptive systems and/or other complex systems, such as expert systems, for example. Similarly, as mentioned, the data aggregation modules 301, 302, . . . data analysis modules 311, 312, . . . and data representation modules 321, 322, . . . can be connected at least to some extent recursively by means of the data channels 41 via the workflow module 40, for example. The invention can also be implemented in the form of a computer program product in connection with the appropriate means, for example, which computer program product comprises a computer-readable medium containing computer program code means for automatically producing complex control and/or analysis apparatuses and which computer program product is used to aggregate, analyze and present data from decentralized databases.

1. A method for automatically producing complex control and/or analysis apparatuses, which control and analysis apparatuses are used to aggregate, analyze and present data from decentralized databases (50), characterized
in that a task-specific organization profile (20) is produced on the basis of at least task condition data (21) and/or object condition data (22) and/or transfer condition data (23),
in that a first processing unit (30) having at least one data aggregation module (301, 302, . . . ) is generated, with each data aggregation module (301, 302, . . . ) being allocated one or more predefined data transmission protocols (300) and/or access protocols (300) for the databases (50) which are to be analyzed,
in that a second processing unit (31) having at least one data analysis module (311, 312, . . . ) is generated, with each data analysis module (311, 312, . . . ) being allocated one or more predefined metadata types (310) and/or analysis units (310), which metadata types and/or analysis units are taken as a basis for analyzing aggregated data from the decentralized databases (50),
in that a third processing unit (32) having at least one data representation module (321, 322, . . . ) is generated, with each data representation module (321, 322, . . . ) being allocated one or more predefined data presentation modules (320), and in that data channels (41) generated by a workflow module (40) are used to connect the at least one data aggregation module (301, 302, . . . ) and/or data analysis module (311, 312, . . . ) and/or data representation module (321, 322, . . . ) in an association, with a flow of data being defined by means of data channels (41) between the modules (301, 302, 311, 312, 321, 322, . . . ) in line with the task-specific organization profile (20).

2. The method as claimed in claim 1, characterized in that the task-specific organization profile (20) is produced automatically by means of an expert module (27).

3. The method as claimed in claim 1, characterized in that the association by the data channels (41) is made at least to some extent dynamically.

4. The method as claimed in claim 1, characterized in that the databases (50) are accessed via network nodes connected to a network (60).

5. The method as claimed in claim 1, characterized in that the metadata (310) are generated at least to some extent dynamically.

6. The method as claimed in claim 5, characterized in that the metadata (310) are generated at least to some extent dynamically on the basis of the data from the task-specific organization profile (20).

7. The method as claimed in claim 1, characterized in that output data from the control and/or analysis apparatuses and/or references to data output are made available to a user in a form stored in a data store in a content module.

8. The method as claimed in claim 1, characterized in that at least one of the decentralized databases (509) is used to store output data from the control and/or analysis apparatuses, with the data aggregation modules (301, 302, . . . ) accessing this at least one database.

9. The method as claimed in claim 1, characterized in that data aggregation modules (301, 302, . . . ), data analysis modules (311, 312, . . . ) and data representation modules (321, 322, . . . ) are connected at least to some extent recursively by means of the data channels (41) via the workflow module (40).

10. A system for automatically producing complex control and/or analysis apparatuses, which complex control and analysis apparatuses can be used to aggregate, analyze and present data from decentralized databases (50), characterized
in that the system comprises a first processing unit (30) having at least one data aggregation module (301, 302, . . . ), with each data aggregation module (301, 302, . . . ) being able to be allocated one or more predefined data transmission protocols (300) and/or access protocols (300) for the databases (50) which are to be analyzed,
in that the system comprises a second processing unit having at least one data analysis module (311,312, . . . ), with each data analysis module (311, 312, . . . ) being able to be allocated one or more predefined metadata types (310) and/or analysis units (310), which can be taken as a basis for analyzing aggregated data from the decentralized databases (50),
in that the system comprises a third processing unit (32) having at least one data representation module (321, 322, . . . ), with each data representation module (321, 322, . . . ) being able to be allocated one or more predefined data presentation modules (320), and
in that the system comprises a workflow module (40) which can be used to associate the at least one data aggregation module (301, 302, . . . ) and/or data analysis module (311, 312, . . . ) and/or data representation module (321, 322, . . . ) with one another and to define a flow of data between the modules (301, 302, 311, 312, 321, 322, . . . ) in line with a task-specific organization profile (20) on the basis of task condition data (21) and/or object condition data (22) and/or transfer condition data (23).

11. The system as claimed in claim 10, characterized in that the system comprises an expert module (27) for automatically producing the task-specific organization profile (20).

12. The system as claimed in claim 10, characterized in that the system comprises means for generating and/or associating the data channels (41) at least to some extent dynamically.

13. The system as claimed in claim 10, characterized in that the databases (50) comprise network nodes which can be used to access the databases (50) via a network (60).

14. The system as claimed in claim 10, characterized in that the system comprises means for dynamically generating the metadata (310).

15. The system as claimed in claim 14, characterized in that the dynamic generation of the metadata (310) is based at least to some extent on the data from the task-specific organization profile.

16. The system as claimed in claim 10, characterized in that output data from the control and/or analysis apparatuses and/or references to data outputs are stored in a data store (71) in a content module (70) such that they can be accessed by a user.

17. The system as claimed in claim 10, characterized in that at least one of the decentralized databases (50) comprises output data from the control and/or analysis apparatuses.

18. The system as claimed in claim 10, characterized in that data aggregation modules (301, 302, . . . ), data analysis modules (311, 312, . . . ) and data representation modules (321, 322, . . . ) are connected recursively by means of the data channels (41) via the workflow module (40).

19. A computer program product which comprises a computer-readable medium containing computer program code means for automatically producing complex control and/or analysis apparatuses, which computer program product is used to aggregate, analyze and present data from decentralized databases,
in that a first processing unit (30) having at least one data aggregation module (301, 302, . . . ) is generated, with each data aggregation module (301, 302, . . . ) being allocated one or more predefined data transmission protocols (300) and/or access protocols (300) for the databases (50) which are to be analyzed,
in that a second processing unit (31) having at least one data analysis module (311, 312, . . . ) is generated, with each data analysis module (311, 312, . . . ) being allocated one or more predefined metadata types (310) and/or analysis units (310), which are taken as a basis for analyzing aggregated data from the decentralized databases (50),
in that a third processing unit (32) having at least one data representation module (321, 322, . . . ) is generated, with each data representation module (321, 322, . . . ) being allocated one or more predefined data presentation modules (320), and
in that a workflow module (40) is used to connect the at least one data aggregation module (301, 302, . . . ), data analysis module (311, 312, . . . ) and data representation module (321, 322, . . . ) in an association, with the flow of data being defined by means of data channels (41) between the modules (301, 302, 311, 312, 321, 322, . . . ) in line with a task-specific organization profile (20).

20. A computer program product which can be loaded into the internal memory of a digital computer and comprises software code sections which can be used to perform the steps as claimed in claim 1 when the product is running on a computer.
